(19) United States
(12) Patent Application Publication
(10) Pub. No.: US 2025/0258827 A1
(43) Pub. Date: Aug. 14, 2025

(54) GRAPHICAL USER INTERFACE FOR FIREARM NOTIFICATIONS ON A MOBILE COMPUTING DEVICE

(71) Applicant: CARRY SOUND LLC, Northville, MI (US)

(72) Inventor: Matthew Mroue, Northville, MI (US)

(21) Appl. No.: 19/171,559

(22) Filed: Apr. 7, 2025

Related U.S. Application Data
(63) Continuation of application No. 18/321,848, filed on May 23, 2023.
(60) Provisional application No. 63/492,521, filed on Mar. 28, 2023.

(51) Int. Cl. G06F 16/2457; G06F 16/29

(52) U.S. Cl. CPC G06F 16/24575; G06F 16/29

(57) ABSTRACT

A graphical user interface includes a first display window having an interactive map that displays a plurality of venues. An icon on the interactive map is associated with a geographical location of the mobile computing device. The first display window displays the respective venues based on the geographical location of the mobile computing device. At least one indicator including a venue graphic selectively overlays a geographical location of the respective venue on the interactive map in response to the geographical location of the venue being within a preselected proximity of the icon. A visual contrast of the venue graphic is depicted in the first display window based on an assigned confidence level based on a degree of confidence that a user associated with a respective user record is authorized to establish a firearms policy record for the respective venue.

### CROSS-REFERENCE TO RELATED APPLICATION

This application is a continuation of States application Ser. No. 18/321,848 filed on May 23, 2023, which claims the benefit of U.S. Provisional Application No. 63/492,521 filed on Mar. 28, 2023, which is incorporated herein by reference in its entirety.

### BACKGROUND

This disclosure relates to firearms, and more particularly, to systems and methods of notifying users of firearms restrictions.

Various governmental and non-governmental entities may impose restrictions on firearms carriers. These restrictions may include an ability to open and/or conceal carry a firearm on the premises.

### SUMMARY

A firearm notification system according to an implementation may include a processor coupled to memory. The processor may be configured to determine a geographical location of a computing device. The processor may be configured to select a venue record from a plurality of venue records based on the determined geographical location. Each of the venue records may include a respective firearms policy record. The processor may be configured to select at least one user record from a plurality of user records. Each of the user records may be associated with one or more of the venue records. The processor may be configured to determine an authorization status for the selected at least one user record. The authorization status may be based on whether the selected at least one user record is authorized to establish the firearms policy record for the selected venue record. The processor may be configured to cause at least one indicator to be displayed on a display coupled to the computing device. The at least one indicator may be associated with the selected venue record based on the respective firearms policy record and the determined authorization status of the selected at least one user record.

In implementations, the computing device may include the processor.

In implementations, the processor may be configured to determine the authorization status in response to validating an identity of a user associated with the selected at least one user record.

In implementations, the processor may be configured to determine a confidence level based on a degree of confidence that a user associated with the selected at least one user record is authorized to establish the firearms policy record of the selected venue record. The at least one indicator may include a graphic associated with the confidence level.

implementations, the processor may be configured to cause the at least one indicator to be displayed in response to the determined confidence level meeting one or more confidence level thresholds, but exclude display of information associated with the firearms policy record in response to the determined confidence level not meeting the one or more of the confidence level thresholds.

In implementations, the processor may be configured to adjust the one or more confidence level thresholds in response to user interaction with the computing device.

In implementations, the processor may be configured to determine the confidence level based on two or more selected user records of the plurality of user records that are associated with the selected venue.

In implementations, the processor may be configured to assign to the authorization status for each of the two or more selected user records a respective authorization status type of a set of authorization status types. The set of authorization status types may include an unverified authorization type and verified authorization status type.

In implementations, the two or more selected user records may include a first user record and a second user record. The first user record may be associated with the unverified authorization type. The second user record may be associated with the verified authorization type.

In implementations, the at least one indicator may include a graphic associated with the geographical location and/or perimeter of a venue of the selected venue record.

In implementations, the processor may be configured to determine a confidence level based on a degree of confidence that a user associated with the selected at least one user record may be authorized to establish the firearms policy record of the selected venue record. The graphic may be associated with the confidence level.

A firearm notification system according to an implementation may include a processor coupled to memory. The processor may be configured to receive one or more submissions from one or more users each associated with a respective user record. The one or more submissions may be associated with a firearms policy of a venue. The processor may be configured to generate a firearms policy record associated with the firearms policy. The processor may be configured to generate a venue record associated with the venue. The processor may be configured to associated with the firearms policy record with the venue record. The processor may be configured to determine an authorization status for each user record associated with the firearms policy record. The authorization status may be based on whether the respective user record is authorized to establish the firearms policy record for the respective venue. The processor may be configured to assign a verification status to the firearms policy record associated with the venue. The verification status may be based on the determined authorization status of each user record associated with the one or more submissions.

In implementations, the processor may be configured to determine a confidence level based on a degree of confidence that each user associated with the respective user record may be authorized to establish the firearms policy associated with the venue. The processor may be configured to assign the confidence level to the firearms policy record.

In implementations, the confidence level may be a weighted average based on the authorization status of each user record associated with the firearms policy record.

In implementations, the processor is configured to determine the confidence level based on a duration since the respective submission.

In implementations, the processor is configured to cause at least one indicator to be displayed on a display coupled to the processor. The at least one indicator may be based on the firearms policy record and the determined authorization status of each user record associated with the firearms policy record.

In implementations, the at least one indicator may include a graphic associated with the confidence level.

A method of notification according to an implementation may include determining a geographical location of a computing device. The method may include selecting a venue record from a plurality of venue records based on the determined geographical location. Each of the venue records may include a respective firearms policy record. The method may include selecting at least one user record from a plurality of user records. Each of the user records may be associated with one or more of the venue records. The method may include determining an authorization status for the selected at least one user record. The authorization status may be based on whether the selected at least one user record is authorized to establish the firearms policy record for the selected venue record. The method may include causing at least one indicator to be displayed on a display coupled to the computing device. The at least one indicator may be associated with the selected venue record based on the respective firearms policy record and the determined authorization status of the selected at least one user record.

In implementations, the at least one user record may include a set of user records selected from the plurality of user records. The method may include determining a confidence level based on a degree of confidence that respective users associated with the selected set of user records are authorized to establish the firearms policy record of the selected venue record. The at least one indicator may include a graphic associated with the confidence level.

In implementations, the step of causing the at least one indicator may occur in response to the determined confidence level meeting one or more confidence level thresholds.

In implementations, a firearm notification system, non-transitory computer-readable media and/or method therefore may include any feature described herein, individually or in combination with any other feature or features described herein.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 illustrates a system for firearms notification.

FIG. 2 illustrates a computing device incorporating a firearms notification environment.

FIG. 3 illustrates a first display window.

FIG. 4 illustrates a second display window.

FIG. 5 illustrates a third display window.

FIG. 6 illustrates a fourth display window.

FIG. 7 illustrates a fifth display window.

FIGS. 8-9 illustrate a sixth display window.

FIGS. 10-14 illustrate a seventh display window.

FIG. 15 illustrates an exemplary table of parameters that may be utilized to establish a confidence level.

FIG. 16 illustrates an implementation of the seventh display window.

FIG. 17 illustrates a process for providing a firearms policy notification.

Like reference numbers and designations in the various drawings indicate like elements.

### DETAILED DESCRIPTION

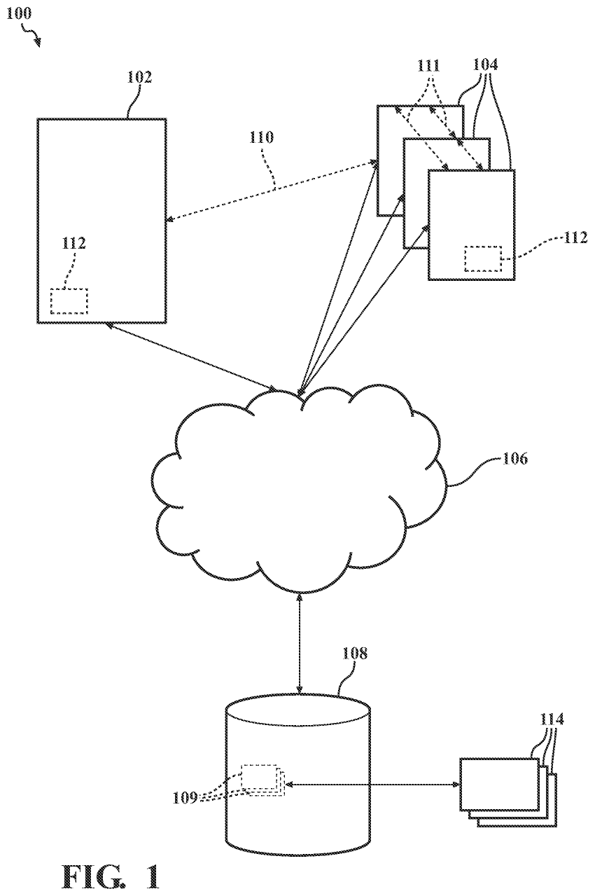

FIG. 1 illustrates an example computing architecture or (e.g., firearms notification) system 100 for executing a firearms notification environment. The system 100 may include a host computer 102. The host computer 102 may include one or more of a computer processor, memory, storage means, network device, and input and/or output devices and/or interfaces. The host computer 102 may be configured to execute one or more software programs. The host computer 102 may be more than one computer jointly configured to process software instructions serially or in parallel.

The host computer 102 may be in communication with one or more networks such as a network 106 comprised of one or more computing devices. The system 100 may include one or more client computers 104. The host computer 102 and the one or more client computers 104 may include one or more of a computer processor, memory, storage means, network device and input and/or output devices and/or interfaces. The memory may, for example, include UVPROM, EEPROM, FLASH, RAM, ROM, DVD, CD, a hard drive, or other computer readable medium which may store data and/or the notification software of this description. The host computer 102 and the one or more client computers 104 may be a desktop computer, laptop computer, smart phone, tablet, or any other computer device. In implementations, one or more of the host computer 102 and the one or more client computers 104 may include an input device, such as a keyboard and mouse, and one or more output devices such as a monitor, speakers, printers, etc. The interface may facilitate communication with the other systems and/or components of the network 106.

Each of the client computers 104 may be adapted to access and locally run notification software and providing a notification environment 112. The notification environment 112 may incorporate any of the features disclosed herein. In implementations, the notification environment 112 may include one or more graphical user interfaces (GUI).

In implementations, the one or more client computers 104 may be configured to communicate with the host computer 102 directly via a direct client interface 110 or over the network 106. The one or more client computers 104 may be configured to execute one or more software programs, which may provide any of the features disclosed herein. In implementations, the one or more client computers 104 may be configured to communicate with each other directly via a peer-to-peer interface 111.

The network 106 may be a private local area network (LAN), a private wide area network (WAN), the Internet, a mesh network, or any other network. The system 100 may include at least one storage system 108. The storage system 108 may be operable to store or otherwise provide data to other computing devices. In implementations, the storage system 108 may be a storage area network device (SAN) configured to communicate with the host computer 102 and/or the one or more client computers 104 over the network 106. In implementations, the storage system 108 may be located within the host computer 102 or within at least one of the client computers 104. The storage system 108 may be configured to store one or more of computer software instructions, data, database files, configuration information, etc.

In implementations, the system 100 may be a client-server architecture configured to execute computer software on the host computer 102, which may be accessible by the one or more client computers 104 using either a thin client application or a web browser executing on the one or more client computers 104. In implementations, the host computer 102 may be configured to load the computer software instructions from local storage, or from the storage system 108, into memory and executes the computer software using the one or more computer processors.

The system 100 may include one or more databases 109. The databases 109 may be stored at and/or accessible from any of the computing devices disclosed herein, such as the host computer 102 and/or client computers 104. The database 109 may be stored in a respective storage system 108. In implementations, the database 109 may be stored at host computer 102 or may be a distributed database provided by one or more of the client computers 104. The database 109 may be a relational database configured to associated various data and information, including any of the records and files disclosed herein. Each record and/or file may be associated with a unique identifier or database entry. The database 109 may be configured to linked or otherwise associate one or more files. Multiple users each provided with a notification environment 112 via the client computers 104 may be able to simultaneously access each record and/or file stored in or otherwise associated with the database 109.

The databases 109 may be associate with one or more external records 114. The external records 114 may be stored in one or more records systems. The external records 114 may include any of the records disclosed herein, including governmental and/or non-government records associated with one or more venues, such as business records and corporate filings.

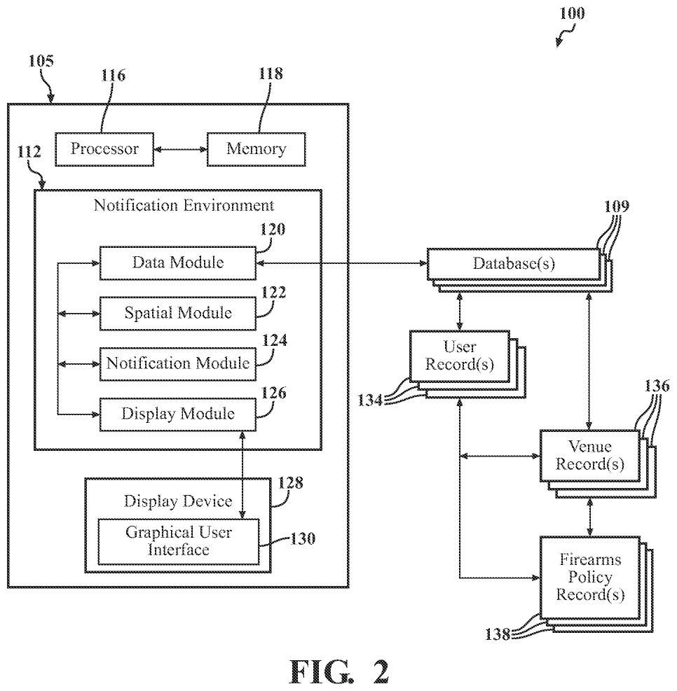

FIG. 2 discloses a computing device 105 according to an implementation. The computing device 105 may establish a firearm notification system and/or a portion thereof. The computing device 105 may incorporate any of the functionality disclosed herein, including the firearm notification system 100 of FIG. 1. The computing device 105 may include any of the computing devices disclosed herein, including a mobile device such as a cellular phone, tablet or laptop. The computing device 105 may be the host computer 102 and/or one of the client computers 104 of FIG. 1.

The computing device 105 may include a processor 116 coupled to memory 118. The processor 116 may be configured to execute a firearms notification environment, such as the firearms notification environment 112. The firearms notification environment 112 may include a data module 120, spatial module 122, notification module 124 and/or display module 126. Although four modules are disclosed, it should be understood that the firearms notification environment 112 may incorporate fewer or more than four modules, which may be combined or separated to provide any of the functionality disclosed herein.

The data module 120 may be configured to interface with the database(s) 109 to obtain data and other information associated with database records and/or files.

The spatial module 122 may be configured to determine various geographical locations, including a present geographical location of a computing device, such as the computing device 105. The geographical location may be associated with coordinate data. The spatial module 122 may incorporate and/or interface with a global positioning system (GPS) or other navigation system to determine the coordinate data.

The display module 126 may be coupled to a display (e.g., display device) 128. The display module 126 may be configured to execute a graphical user interface (GUI) 130. The display module 126 may be configured to cause the display device 128 to display the graphical user interface 130. The graphical user interface 130 may be responsive to one or more user inputs, including interaction with the display device 128. The graphical user interface 130 may be configured to display any of the windows and information disclosed herein.

The notification module 124 may be configured to execute any of the notification features disclosed herein. The notification module 124 may be configured to generate, query, edit and/or delete records and/or files associated with the databases 109 and/or external records 114. The external records 114 may be stored in one or more records systems and may include any of the records disclosed herein, such as business records associated with one or more venues, including corporate filings (e.g., incorporation documents, annual filings, etc.). The notification module 124 may be configured to cause the display module 126 to display any of the information and other features disclosed herein.

The system 100 may include one or more user records 134, venue records 136 and/or firearms policy records 138. The notification module 124, notification environment 112 and/or another portion of the system 100 may be configured to associate each firearms policy record 138 with a respective one of the user records 134 and/or venue records 136. The user records 134, venue records 136 and/or firearms policy records 138 may be stored in and/or otherwise associated with each other and/or the database(s) 109. Each user record 134 may be associated with a unique user. Each venue record 136 may be associated with a unique venue. Each firearms policy records 138 may be unique to one of the venue records 136 and/or may be common to two or more venue records 136 (e.g., for a chain or corporate-wide policy). The venue record 136 may be associated with various indoor and outdoor venues, including any of the venues disclosed herein, such as a municipal or other government locations (e.g., government buildings, parks, streets and roads, etc.), businesses (e.g., stores, shops, offices, supermarkets, gas stations, banks, etc.) and residences.

The notification module 124 may be configured to cause the data module 120 to select a venue record 136 from a plurality of venue records 136 based on a geographical location, such as a determined geographical location of the computing device 105. Each of the venue records 136 may include or may otherwise be associated with respective firearms policy record(s) 138. The notification module 124 may be configured to cause the data module 120 to select at least one user record 134 from a plurality of user records 134. Each user record 134 may be associated with one or more of the venue records 136.

Each firearms policy record 138 may be associated with a firearms policy of a respective venue. The firearms policy records 138 may include one or more parameters for characterizing the respective firearms policy. The parameters may include whether firearms are permitted and/or restricted at venue(s) associated with the respective venue record(s) 136. The parameters may include whether concealed carry and/or open carry is permitted and/or restricted at venue(s) associated with the respective venue record(s) 136.

The notification module 124 may be configured to determine an authorization status for each (e.g., selected) user record(s) 134. The authorization status may include any of the authorization status types disclosed herein. The authorization status may be based on whether the selected user record(s) 134 is authorized to establish the firearms policy record(s) 138 for the selected venue record(s) 136. The notification module 124 may be configured to determine the authorization status in response to validating an identity of a user associated with the (e.g., selected) user record 134. The notification module 124 may be configured to validate the user identity utilizing any of the techniques and information disclosed herein.

The notification module 124 may be configured to determine a verification status for each (e.g., selected) venue record(s) 136. The verification status may include any of the verification status types disclosed herein.

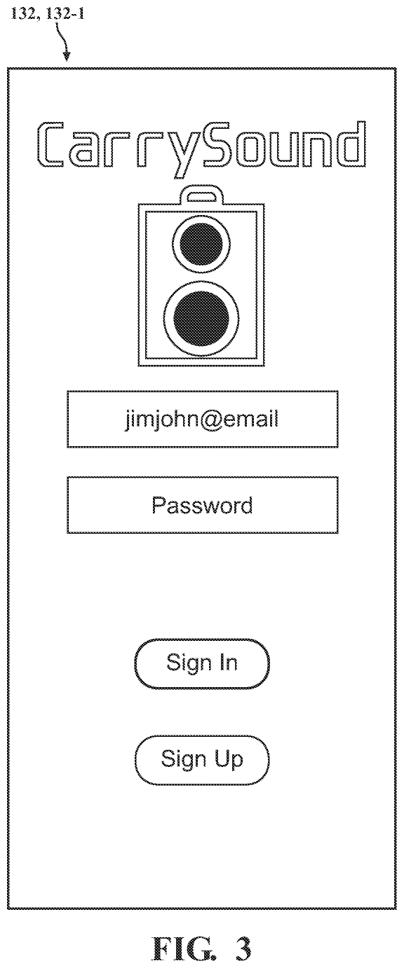

Referring to FIG. 3, with continuing reference to FIG. 2, the graphical user interface 130 may include one or more display windows 132. The display windows 132 may include a first display window 132-1. The first display window 132-1 may be a log-on window. A user provided with the computing device 105 may interface with the display window 132-1 to access the notification environment 112 and/or firearms notification system 100.

The notification environment 112 and/or another portion of the system 100 may be configured to generate one or more user records 134. The notification environment 112 may be configured to access, establish and/or edit a user record 134 associated with a respective user in response to interaction with the display window 132-1 and/or another portion of graphical user interface 130.

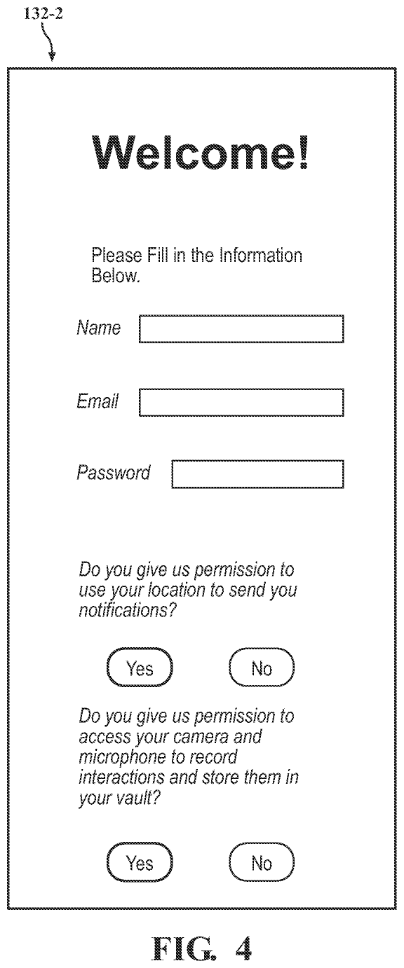

Referring to FIG. 4, with continuing reference to FIGS. 2-3, the display windows 132 may include a second display window 132-2. The second display window 132-2 may be utilized to establish a user record 134.

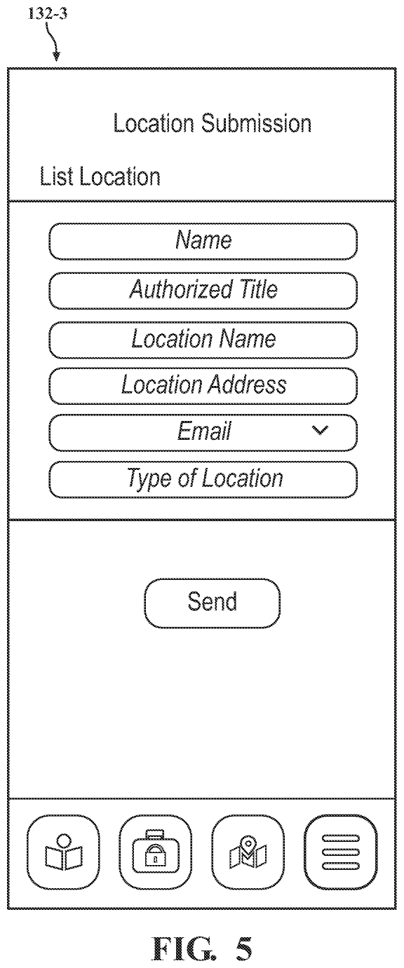

Referring to FIG. 5, with continuing reference to FIG. 2, the display windows 132 may include a third display window 132-3. The third display window 132-3 may be utilized to establish a venue record 136. The notification module 124 and/or another portion of the system 100 may be configured to associate each venue record 136 with one or more user records 134.

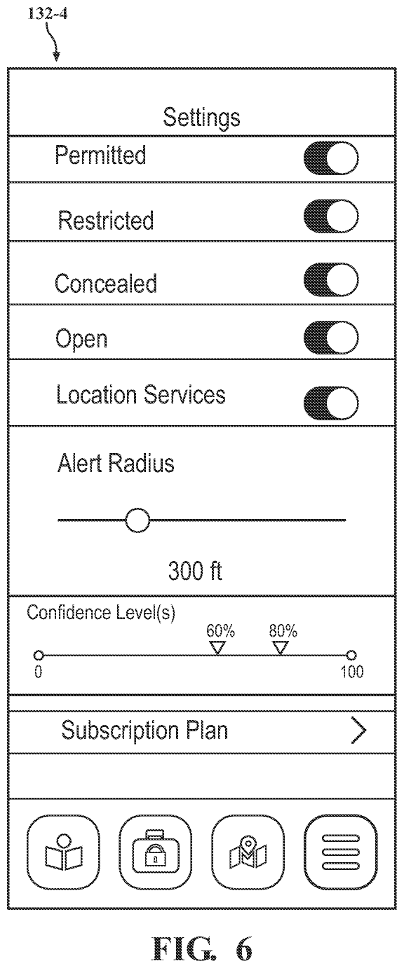

Referring to FIG. 6, with continuing reference to FIG. 2, the display windows 132 may include a fourth display window 132-4. The user may interact with the fourth display window 132-4 and/or another portion of the user interface 130 to select one or more settings associated with the notification environment 112. In implementations, the system 100 may be configured to establish default settings for the user records 134, which may be edited by the user.

The setting may include displaying information in the user interface 130 associated with whether firearms are permitted and/or restricted at venue(s) associated with the respective venue record(s) 136. The settings may include displaying information in the user interface 130 associated with whether concealed carry and/or open carry is permitted and/or restricted at venue(s) associated with the respective venue record(s) 136. The setting may include permitting and/or restricting access to a present geographical location of a computing device executing the notification environment 112, such as the computing device 105. The present geographical location may be associated with a user provided with the computing device 105.

The settings may include a proximity to venues associated with the venue records 136 for generating one or more indicators associated with the firearms policy records 138 of the respective venues. The proximity settings may include an alert radius (e.g., 300 feet).

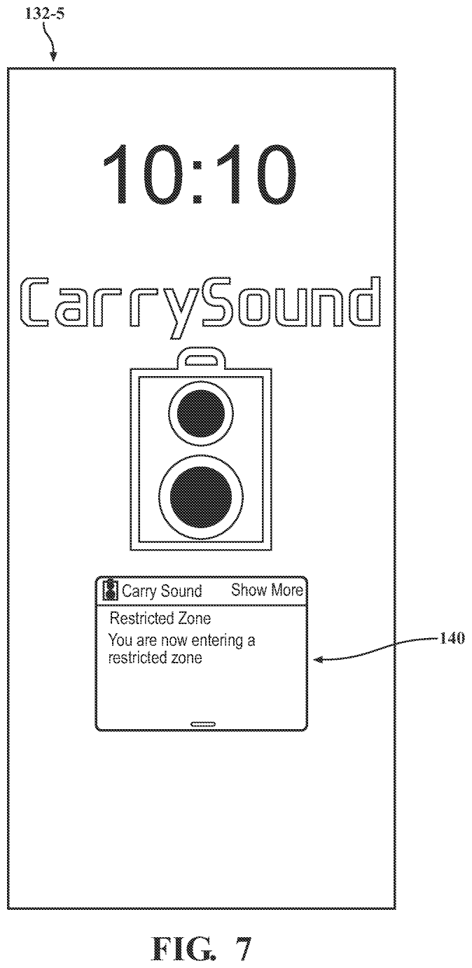

Referring to FIG. 7, with continuing reference to FIG. 2, the display windows 132 may include a fifth display window 132-5. The planning environment 112 may be configured to generate one or more indicators (e.g., notifications) 140. The notification module 124 may be configured to cause the display module 126 to display at least one or more indicators 140 on a display 128 coupled to the computing device 105. The notification environment 112 may be configured to generate various indicators 140, including text and/or graphics. The indicators 140 may include various information associated with the firearms policies of one or more associated venues. The display module 126 may be configured to display the indicator(s) 140 in one or more graphics. The graphics may be associated with the geographical location and/or perimeter of a venue of the selected venue record 136.

Each indicator 140 may be associated with the selected venue record 136 based on the respective firearms policy record 138, a determined authorization status of the (e.g., selected) user record(s) 134 and/or a determined verification status of the (e.g., selected) venue record(s) 136. The indicators 140 may include indicators associated with any of the parameters disclosed herein (e.g., firearms permitted, firearms restricted, concealed carry and/or open carry permitted and/or restricted, etc.). The indicators 140 may be generated based on one or more of the venue records 136 and/or firearms policy records 138. The notification module 124 may be configured to cause the display module 126 to display the indicators 140 based on a geographical location of the computing device 105 (e.g., radius, perimeter, etc.). The notification environment 112 may be configured to generate the indicators 140 based on setting(s) specified by or otherwise associated with the user record 134 (see, e.g., FIG. 6).

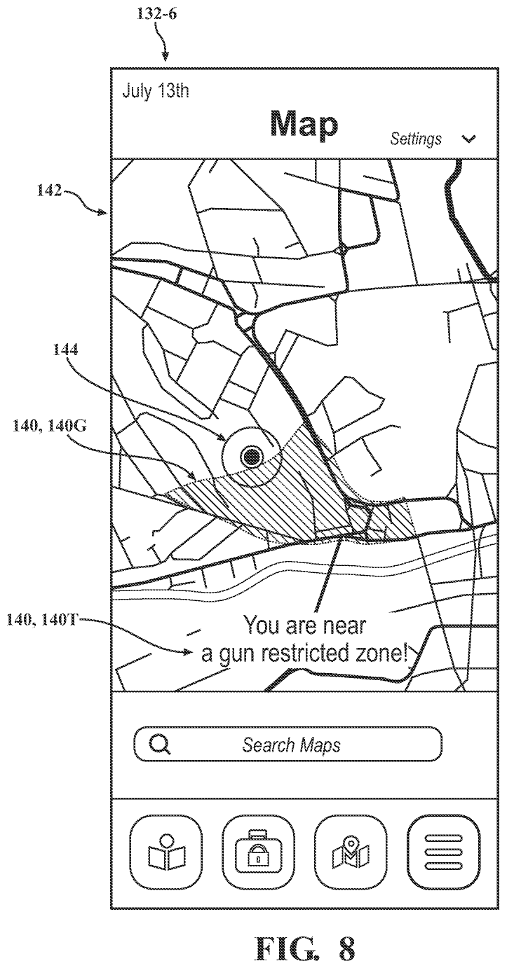

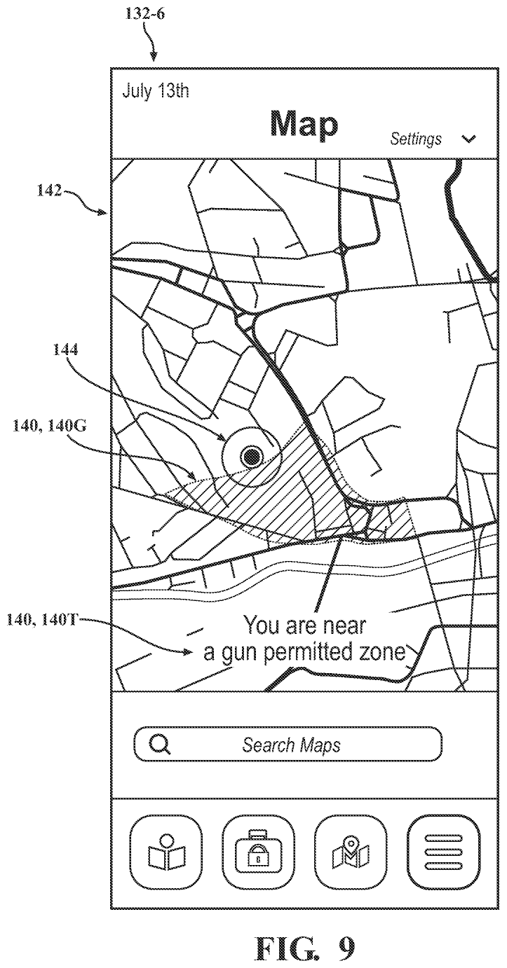

Referring to FIGS. 8-9, with continued reference to FIG. 2, the display windows 132 may include a sixth display window 132-6. The sixth display window 132-6 may be associated with an interactive map 142. The notification module 124 may be configured to cause the display module 126 to display an icon 144 relative to the map 142. The icon 144 may be associated with a present geographical location of the computing device 105. The icon 144 may include information associated with proximity setting(s) for the respective user record 134, such as a perimeter or radius with respect to the present geographical location.

The notification module 124 may be configured to cause the display module 126 to display one or more indicators 140 relative to the map 142. The indicators 140 may include graphical indicator(s) 140G and/or textual indicator(s) 140T. The notification module 124 may be configured to generate one or more audible indicators. The notification module 124 may be configured to generate the graphical indicator(s) 140G and/or textual indicator(s) 140T based on one or more of the venue records 136 and/or firearms policy records 138. The notification module 124 may be configured to cause the display module 126 to display the indicators 140G, 140T based on a geographical location of the computing device 105 (e.g., radius, perimeter, etc.) relative to a geographical location of one or more venues associated with the respective venue records 136. The notification module 124 may be configured to generate the notification(s) 140 in response to determining that the computing device 105 is within a predetermined proximity of the venue(s) of the associated venue record(s) 136.

Various techniques may be utilized to establish the graphical indicator 140G and textual indicators 140T. In the implementation of FIG. 8, the graphical indicator 140G may include a characteristic (e.g., color or shading) associated with a restricted zone. The textual indicator 140T may include a text string associated with the characteristic of the restricted zone (e.g., “You are near a gun restricted zone!”). In the implementation of FIG. 9, the graphical indicator 140G may include a characteristic (e.g., color or shading) associated with a unrestricted zone. The textual indicator 140T may include a text string associated with the characteristic of the unrestricted zone (e.g., “You are near a gun permitted zone!”).

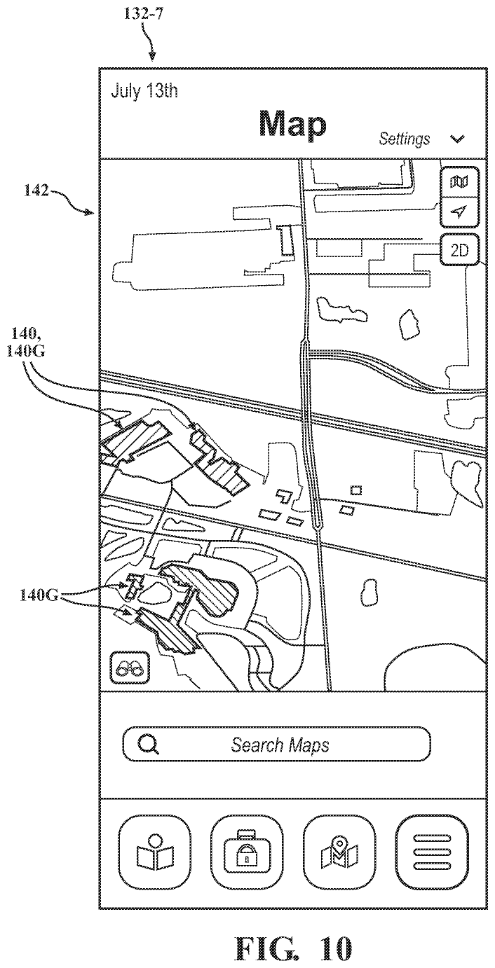

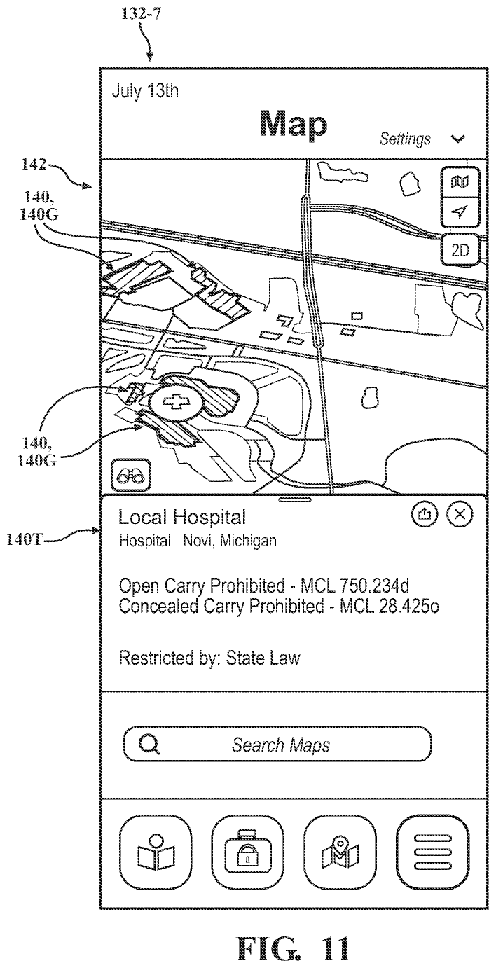

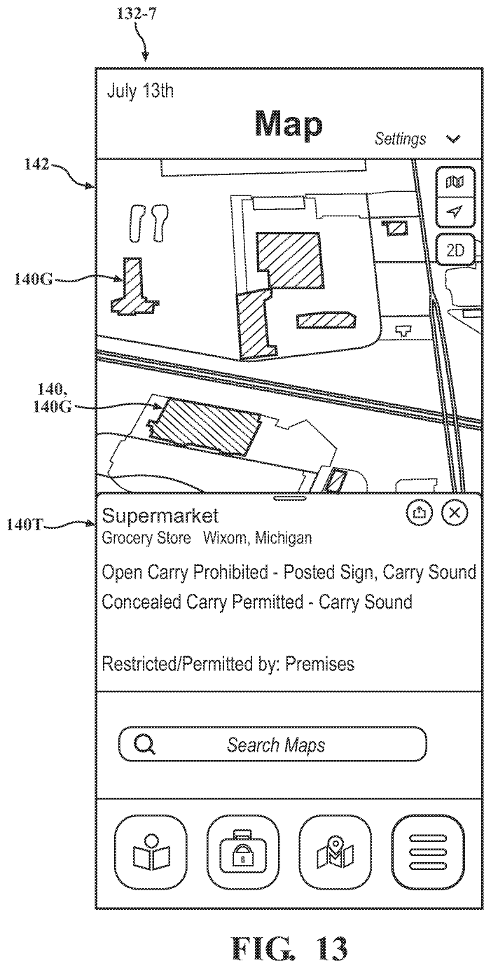

Referring to FIGS. 10-13, with continued reference to FIG. 2, the display windows 132 may include a seventh display window 132-7. The seventh display window 132-7 may be associated with the interactive map 142. The display module 126 may be configured to display one or more textual indicators 140T in a text box (e.g., pop-up windows of FIGS. 11 and 13). The textual indicator 140T may include information associated with the firearms policy of a selected venue. The user may interact with the display window 132-7 to select the venue on the interactive map 142. In the implementations of FIGS. 11 of 13, the textual indicator 140T may present information associated with a firearms policy having one or more restrictions and/or permissions (e.g., open carry and concealed carry prohibited). The textual indicator 140T may present information associated with a firearms policies having one or more restrictions and/or one or more permissions (e.g., open carry prohibited, but concealed carry permitted). The textual indicator 140T may include information associated with signage representative of the associated permissions and/or restrictions.

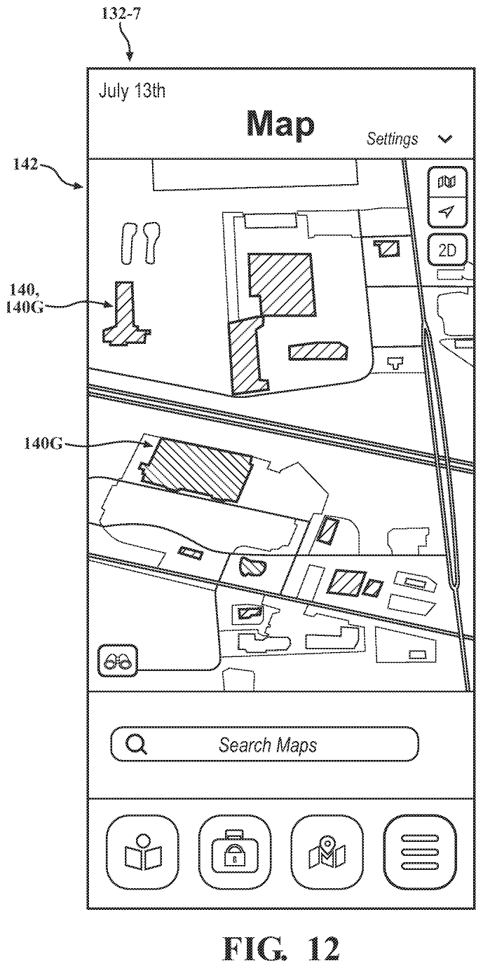

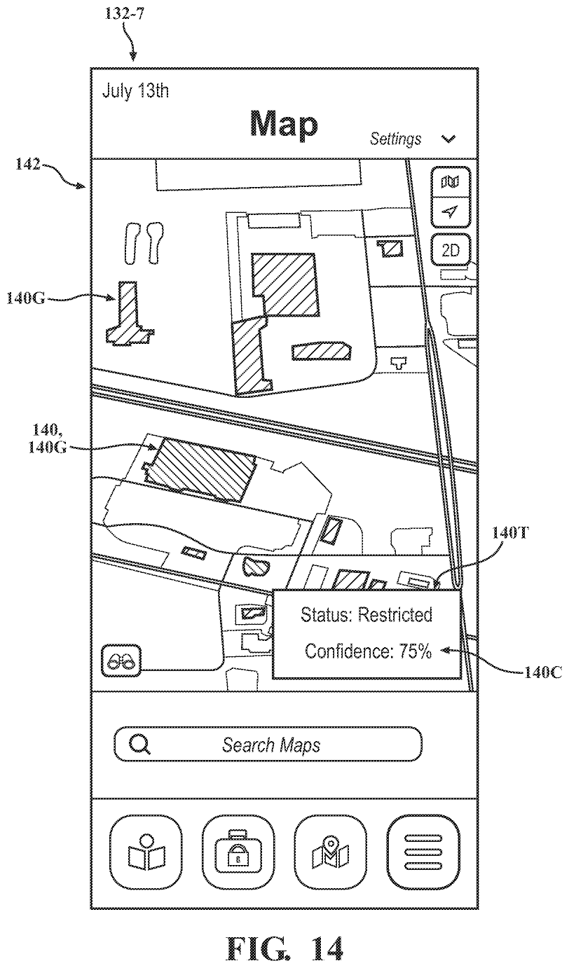

Referring to FIG. 14, with continuing reference to FIGS. 12-13, the notification module 124 and/or another portion of the notification environment 112 and/or system 100 may be configured to determine a confidence level associated with a confidence that report(s) of the firearms policy correctly represents the actual firearms policy of the respective venue. The confidence level may be a numerical value and/or range of values (e.g., 75 percent confidence).

Various techniques may be utilized to establish the confidence level. In implementations, the confidence level may be a weighted average based on whether or not the user associated with the reported firearms policy can be verified as an authorized representative of the venue (e.g., verified users may be assigned a higher weight than non-verified users). Verified users may include business owners, representatives and/or other employees. Various sources may be utilized to verify users who submit a firearms policy record, including any of the records and other information disclosed herein. In implementations, verification sources may include business records, a signed declaration or affidavit, a digital authentication means (e.g., unique pin code or password, electronic signature, etc.). Non-verified users may include customers and/or other members of the general public. Non-verified users may include persons officially associated with the venue but cannot be verified based on information accessible by the system 100. Other criteria for determining the confidence level may include a duration since the submitting of the firearms policy report of the associated firearms policy record 138 (e.g., more recent reports given a relatively higher weight). The notification module 124 may be configured to determine a confidence level based on a degree of confidence that a user associated with the (e.g., selected) user record 134 is authorized to establish the firearms policy record 138 of the (e.g., selected) venue record 136. The notification module 124 may be configured to determine the confidence level based on two or more (e.g., selected) user records 134 of the plurality of user records 134 that are associated with the venue record 136 of the selected venue.

The user may interact with the user interface 130 to specify one or more settings associated with the confidence level. In implementations, the user may specify to include and/or exclude verified users, unverified users and/or relatively older firearms policy reports for determining the confidence level. In the implementation of FIG. 6, the user may interact with object(s) in the display window 132-4 and/or another portion of the user interface 130 to adjust, set or otherwise specify one or more confidence level thresholds. Confidence level thresholds may be established for a first (e.g., “partially” verified) verification status type and/or a second (e.g., “verified” “fully verified”) verification status type. The objects may include a sliding bar in which the user may set confidence level thresholds. The display module 48 may be configured to display the associated firearms policy record information in response to the confidence level meeting one or more of the confidence level thresholds (e.g., 60 percent or 80 percent), but may be configured to exclude display of the associated firearms policy record information in response to the confidence level being below or otherwise not meeting one or more of the confidence level thresholds.

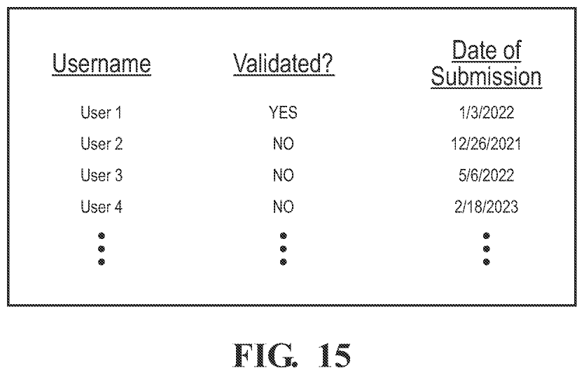

The indicator(s) 140 may include one or more graphics associated with the confidence level. The indicators 140 may include a confidence indicator 140C associated with the determined confidence level. The confidence indicator 140C may be a numerical value or a position along a gradient scale. FIG. 15 illustrates an exemplary table of parameters that may be utilized to establish a confidence level, which may be represented by the confidence indicator 140C.

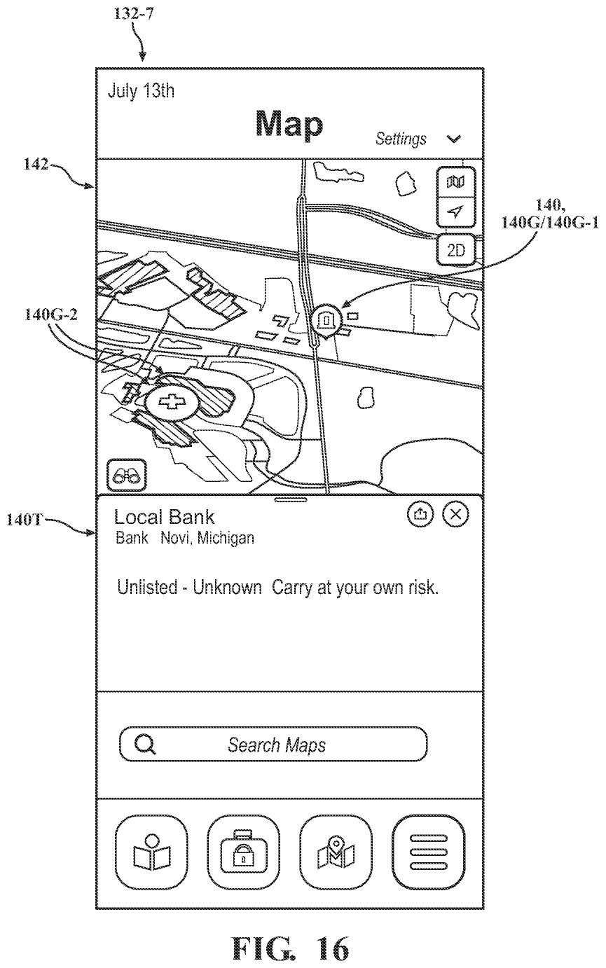

Referring to FIG. 16, with continuing reference to FIGS. 10-13, the firearms policy may be unlisted or otherwise unknown for one or more venues. These venues may be subject to restriction(s) by state law and/or municipal ordinances. The notification module 124 may be configured to determine that a firearms policy record 138 has not been established for the venue record 136 of the respective venue and/or cannot be verified utilizing accessible external records 114. The notification module 124 may be configured to associate the venue record 136 with an “unknown” verification status type. The display module 126 may be configured to display one or more indicators 140, including textual indicators 140T and/or graphical indicators 140G, associated with each venue assigned the unknown verification status (see, e.g., graphical indicator 140G-1). The display module 126 may be configured to display indicators 140 for venues in which the firearms policy is verified or otherwise known (see, e.g., graphical indicator 140G-2) on the same map 142. The textual indicators 140T may include one or more warnings (e.g., “carry at your own risk”). Each graphical indicator 140G may be generated based on the confidence level of the respective venue. In implementations, a visual contrast of the graphical indicator 140G may be established based on confidence level, range of confidence levels and/or confidence level thresholds. The visual contrast may be established based on a color scheme, gradient, hatching, etc. associated with a range of confidence levels and/or confidence level threshold(s) (see, e.g., graphical indicators 140G of FIGS. 8-14).

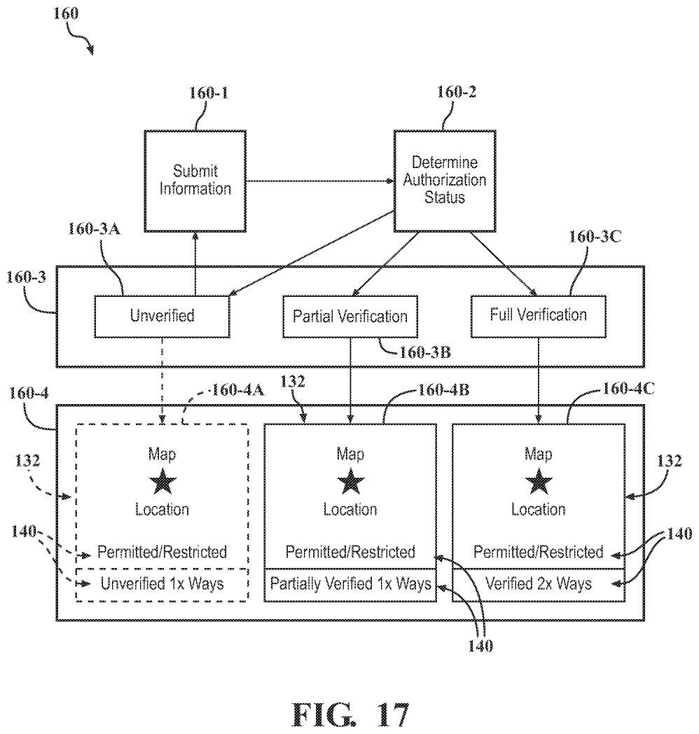

FIG. 17 illustrates an algorithm in a flowchart 160 for providing a firearms policy notification. The notification environment 112 and/or system 100 may be configured to implement any of the features of algorithm 160. Fewer or additional steps than are recited below could be performed within the scope of this disclosure, and the recited order of steps is not intended to limit this disclosure. Reference is made to the system 100 and notification environment 112.

Referring to FIG. 2, with continuing reference to FIG. 17, at step 160-1 one or more users may submit information (e.g., report) associated with one or more firearms policies. Firearms policy record(s) 138 may be generated based on the submitted information. The firearms policy record 138 may be associated with the user record 134 of the user submitting the information and/or the venue record 136 of the venue associated with the submitted information. Various information may be included in the submission, including name, (e.g., authorized) title, location information (e.g., name, type of location, etc.), and contact (e.g., email address, telephone number, etc.) and other identifying information associated with the user and/or venue. The submission may include various information associated with a venue, such as location address and location type. Step 160-1 may be repeated to populate and/or modify the user records 134, venue records 136 and/or firearms policy records 138, including in response to user interaction with the system 100. Each of the user records 134 may be associated with one or more of the venue records 136. The firearms policy record 138 may include information submitted from a single authorized or unauthorized user or may combine information submitted by two or more authorized and/or unauthorized users.

At step 160-2, an authorization status of the user associated with the venue may be determined. Step 160-2 may include determining whether the user associated with the user record 134 submitting the information at step 160-1 is authorized to establish or otherwise report the firearms policy on behalf of the associated venue. Step 160-2 may include selecting at least one user record 134 from a plurality of user records 134. Step 160-2 may include determining an authorization status for the selected user record 134. The authorization status may be based on whether the selected user record 134 is authorized to establish a firearms policy for the selected venue record 136. Step 160-2 may include querying and/or otherwise accessing one or more databases 109 to make the determination, including any of the databases disclosed herein. Step 160-2 may include querying database(s) 109 associated with a set of venue records 136. Step 160-2 may include querying database(s) 109 associated with a set of user records 134. Verification may be based on querying information from the database(s) 109 and/or other sources associated with federal and/state law, notarized document(s), business record(s) and/or other information associated with the business or other venue, etc. Step 160-2 may include determining whether the firearms policy restricts and/or permits firearms at the venue, including whether concealed and/or open carry is permitted or restricted. The determination may be based on one or more verification documents that may be submitted with the request at step 160-1, including any of the documents disclosed herein.

At step 160-3, the authorization status may be established and associated with the user record 134 based on determination. Various authorization status types may be utilized. An “unverified” authorization status may be established at step 160-3A. The system 100 may assign an “unverified” authorization status to venues in which the system 100 is unable to verify the record 134 associated with the submitting user. A “partial verification” authorization status may be established at step 160-3B. A venue associated with a partial verification authorization status may be listed with a relatively low confidence indicator (e.g., warning or notification) 140 in the user interface 130. A “full verification” authorization status may be established at step 160-3C. A venue associated with a full verification authorization status may be listed with an indicator (e.g., warning or notification) 140 in the user interface 130 as permitted and/or restricted and a number of ways (e.g., numerical count and/or type) in which the firearms policy may be verified. Although three authorization types are disclosed, it should be understood that fewer or more than three authorization types may be utilized, including only one or two authorization types.

The “unverified” authorization status type may be established when the user record 134 associated with the user cannot be verified based on available information. In implementations, the firearms policy submission may be denied such that a firearms policy record 138 may not be created and/or information submitted to edit an existing firearms policy record 138 may be discarded. The associated venue record 136 may be assigned an “unknown” authorization status type until at least one firearms policy is submitted by a user record 134 that can be verified. In implementations, the associated firearms policy record 138 may be retained in the database 109. The planning environment 28 may be configured to assign the unverified firearms policy record 138 an “unlisted” verification status type in which the associated firearms policy record may not displayed in the display window 132 or otherwise communicated to the user via the user interface 130. The planning environment 28 may be configured to assign the unverified firearms policy record 138 an unverified authorization status type (see, e.g., step 160-4A). The unverified firearms policy may be displayed in the display window 132 or otherwise communicated to the user via the user interface 130. The firearms policy record 138 may be assigned a different authorization status type based on a subsequent verification.

The “partial verify” authorization status type may be established when a confidence in the verification is below a predetermined threshold. The “full verification” authorization status type may be established when a confidence in the verification exceeds the predetermined threshold. The predetermined threshold may be based on the source, quantity and/or age of the information utilized at step 160-2. In implementations, full verification may be determined based on certain information types, such as business records, a signed declaration or affidavit, a digital authentication means (e.g., unique pin code or password, electronic signature, etc.). Partial verification may be based on less formal information types.

Step 160-3 may include establishing a verification status for each venue record 136. The verification status may be associated with one or more verification types, such as an “unverified” status, “partially verified” status and/or “verified” status. The unverified status may be established based on submissions by one or more unverified user records 134 associated with the firearms policy record(s) 138 of the respective venue record 136. The verified status may be established based on submissions by one or more verified user records 134 associated with the firearms policy record(s) 138 of the respective venue record 136. The partially verified status may be established based on a combination of one or more unverified and one or more verified user records 134 associated with the firearms policy record(s) 138 of the respective venue record 136.

At step 160-4, one or more indicators (e.g., notifications) 140 may be generated. The indicators 140 may be generated based on the authorization status of the user record(s) 134 and/or verification status associated with the respective venue record(s) 136. The indicators 140 may include any of the indicators disclosed herein. Step 160-4 may include causing the indicator(s) 140 to be displayed on a display 128 coupled to an associated computing device 105. The indicator(s) 140 may be displayed in one or more display windows 132. Each indicator 140 may be associated with the selected venue record 136 based on the respective firearms policy record(s) 138, determined authorization status of the selected user record(s) 134 and/or determined verification status of the respective venue record(s) 136. The indicators 140 may include an indication of whether and/or to what extent firearms are permitted and/or restricted at the associated venue (e.g., restricted, permitted, etc.). The indicators 140 may include an indication of whether the firearms policy is verified (e.g., “fully verified”), partially verified, unverified or otherwise unknown, how many information sources and/or quantity of users are utilized to establish the verification (e.g., 0 ways, 1 way, 2 ways, etc.).

Indicator(s) 140 may be generated to indicate that the firearms policy record 138 is associated with one or more unverified submissions and/or an “unverified” or “unknown” verification status at step 160-4A. Indicator(s) 140 may be generated indicating that the firearms policy record 138 is associated with one or more unverified and/or partially verified submissions and/or a “partially verified” verification status at step 160-4B. Indicator(s) 140 may be generated indicating that the firearms policy record 138 is associated with one or more verified submissions and/or a “verified” verification status at step 160-4C.

Step 160-4 may include notifying a user of one or more aspects of a firearms policy associated with a respective venue. Step 160-4 may include determining a geographical location of a computing device 105, including any of the computing devices disclosed herein. Step 160-4 may include selecting a venue record 136 from a plurality of venue records 136 based on the determined geographical location. Each of the venue records 136 may include respective firearms policy record(s) 138. Step 160-4 may include generating the indicator(s) 140 in response to the computing device 105 being within a predetermined proximity (e.g., geographic location, perimeter, distance, radius, etc.) of the venue associated with the venue record 136.

The method 160 may incorporate logic. The logic may include an authorized party submitting a firearms policy indicating whether concealed and/or open carry of firearms is permitted and/or restricted at the associated venue. A determination of the submitting user may be made to verify whether the submitting user is an authorized party for the venue. A confidence level may be assigned to the verification status of the firearms policy associated with the venue utilizing any of the techniques disclosed herein. The confidence level associated with the restricted and/or permitted venue(s) may be displayed. The indicator(s) 140 may include a graphic associated with the confidence level (see, e.g., FIG. 14). A user (e.g., submitter) may submit a respective firearms policy to the system 100 indicating whether the respective venue (e.g., premises or location) may restrict and/or permit the concealed and/or open carry of firearms at the venue. The system 100 may be configured to verify whether the user is an authorized party for the respective venue. Method 160 may include assigning a confidence level to the firearms policy by one or more methods (or lack thereof), including any of the document types and techniques disclosed herein. Method 160 may include displaying the confidence level of the firearms policy of the respective venue (restricted, permitted, unknown or otherwise unverified, etc.). In implementations, an unverified (e.g., unknown) listing may default to state law (e.g., permitted or restricted).

The algorithm 160 may be programmed in the notification software directly, may be provided as one or more software plug-ins adapted to work with the native notification software, or may be provided in a standalone program to interface with a notification package to provide the solution. It should be understood that the host computer 102, client computer 104 or other computing device executing the notification environment 112 may be programmed with multiple additional tools, and the various features and tools included can be configured to interoperate with each other according to known principles.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should further be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A graphical user interface for displaying firearm notifications on a mobile computing device comprising:
a first display window including an interactive map that displays a plurality of venues, wherein the venues are associated with respective venue records, the venue records are associated with respective firearms policy records, and the firearms policy records are associated with respective user records and include one or more parameters for characterizing a respective firearms policy of the respective venue;
an icon on the interactive map, the icon associated with a geographical location of the mobile computing device, wherein the first display window displays the respective venues based on the geographical location of the mobile computing device; and
at least one indicator including a venue graphic that selectively overlays a geographical location of the respective venue on the interactive map in response to the geographical location of the venue being within a preselected proximity of the icon;
wherein the at least one indicator is generated based on the firearms policy record associated with the respective venue record and an authorization status of the respective user record, and the authorization status is based on whether the respective user record is authorized to establish the firearms policy record for the respective venue record; and
wherein a visual contrast of the venue graphic is depicted in the first display window based on an assigned confidence level, the assigned confidence level based on a degree of confidence that a user associated with the respective user record is authorized to establish the firearms policy record of the respective venue record.

2. The graphical user interface as recited in claim 1, wherein:
the authorization status is determined in response to validating an identity of the user associated with the respective user record.

3. The graphical user interface as recited in claim 1, wherein:
a gradient of the visual contrast of the venue graphic is depicted in the first display window according the assigned confidence level with respect to a range of confidence levels.

4. The graphical user interface as recited in claim 1, wherein:
the at least one indicator is displayed in response to the assigned confidence level meeting one or more confidence level thresholds, but information associated with the respective firearms policy record is excluded from display in response to the assigned confidence level not meeting the one or more confidence level thresholds.

5. The graphical user interface as recited in claim 4, further comprising:
a second display window including one or more interactive objects that set the one or more confidence level thresholds in response to user interaction.

6. The graphical user interface as recited in claim 5, wherein:
the one or more interactive objects adjust the one or more confidence level thresholds in response to user interaction with a sliding confidence bar associated with a range of selectable confidence levels in the second display window.

7. The graphical user interface as recited in claim 6, wherein:
the one or more interactive objects include first and second interactive objects adjacent to the sliding confidence bar, the first interactive object is associated with a first confidence level threshold, and the second interactive object is associated with a second confidence level threshold, and the first and second interactive objects are slidable along the sliding confidence bar in response to user interaction to adjust the respective first and second confidence level thresholds.

8. The graphical user interface as recited in claim 4, further comprising:
a third interactive object adjacent to a sliding alert bar associated with a range of selectable alert distances, wherein the third interactive object is slidable along the sliding alert bar in response to user interaction to adjust the preselected proximity.

9. The graphical user interface as recited in claim 1, wherein:
the confidence level is assigned based on two or more user records of the plurality of user records that are associated with the respective venue record.

10. The graphical user interface as recited in claim 9, wherein:
the authorization status is assigned a respective authorization type from a set of authorization status types, and the set of authorization status types including an unverified authorization type and verified authorization status type.

11. The graphical user interface as recited in claim 1, wherein:
the venue graphic is associated with a perimeter of the respective venue.

12. The graphical user interface as recited in claim 1, wherein:
the icon includes a ring about a point corresponding to the geographical location of the mobile computing device, and the ring is established by a radius corresponding to the preselected proximity.

13. The graphical user interface as recited in claim 12, wherein:
the venue graphic overlaps with the ring on the interactive map.

14. The graphical user interface as recited in claim 1, wherein:
the confidence level is a weighted average based on the authorization status of each user record associated with the respective firearms policy record.

15. The graphical user interface as recited in claim 1, wherein:
the confidence level is based on a duration since a submission of the respective firearms policy record.

16. The graphical user interface as recited in claim 1, wherein:
the at least one indicator includes a text object that overlays the interactive map at a distance from the venue graphic and the icon, and the text object displays information corresponding to the firearms policy record associated with the venue graphic.

17. The graphical user interface as recited in claim 1, further comprising:
a third display window that displays text associated with one or more parameters that characterize the firearms policy of the firearms policy record associated with the venue graphic;
wherein the third display window is adjacent to the first display window such that the venue graphic and the text are concurrently displayed in the graphical user interface.

18. The graphical user interface as recited in claim 1, wherein:
the at least one indicator includes a summary graphic that displays, concurrently with the venue graphic, a restriction status of the respective firearms policy record and a numerical value of the assigned confidence level.
